(19) United States
(12) Patent Application Publication
(10) Pub. No.: US 2016/0091460 A1
(43) Pub. Date: Mar. 31, 2016

(54) Electrostatic Force Tester

(71) Applicant: NANOMECHANICS, INC., Oak Ridge, TN (US)

(72) Inventors: Warren Oliver, Knoxville, TN (US); Kermit Hunter Parks, Knoxville, TN (US); Sudharshan Phani Pardhasaradhi, Knoxville, TN (US)

(73) Assignee: Nanomechanics, Inc., Oak Ridge, TN (US)

(21) Appl. No.: 14/895,292

(22) PCT Filed: Jun. 3, 2014
(86) PCT No.: PCT/US14/40589

§ 371 Date: Dec. 2, 2015

Related U.S. Application Data
(60) Provisional application No. 61/831,335, filed on Jun. 5, 2013.

(51) Int. Cl. G01N 27/60

(52) U.S. Cl. CPC G01N 27/60

(57) ABSTRACT

An electrostatic force testing apparatus applies an electrostatic force to a test specimen and thereby imparts stress on the specimen. A focused electrostatic force is applied to the test specimen using a shaped probe tip of the electrostatic force testing apparatus. The force applied to the test specimen may be varied based on a distance of the probe tip from the test specimen, a voltage applied to the probe tip, and a shape of the probe tip.

### FIELD

This disclosure relates to the field of mechanical testing. More particularly, this disclosure relates to an apparatus for applying an electrostatic force to a test specimen.

### BACKGROUND

The mechanical properties of a specimen may be learned by applying a force, and therefore a stress, to the specimen. To apply a force to the specimen, a testing apparatus may be required to physically contact the specimen. However, inconsistent measurements may result from the testing apparatus contacting the specimen.

What is needed, therefore, is an apparatus for applying a force to a specimen without physically contacting the specimen and for measuring the amount of force applied to the specimen.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 illustrates an electrostatic force testing apparatus according to one embodiment of the disclosure;

FIG. 2 shows a tip geometry according to one embodiment of the disclosure;

FIG. 3 is a chart of electrostatic force as a function of tip-sample distance according to one embodiment of the disclosure;

FIG. 4 is a chart of electrostatic force as a function of the square of the voltage according to one embodiment of the disclosure;

FIG. 5 is a chart of electrostatic force as a function of tip sample separation at different applied voltages according to one embodiment of the disclosure;

FIG. 6 shows a stress distribution profile according to one embodiment of the disclosure;

FIG. 7 illustrates an electrostatic force testing apparatus according to one embodiment of the disclosure; and

FIG. 8 depicts a close up view of a probe tip adjacent a surface according to an embodiment of the disclosure.

### DETAILED DESCRIPTION

The present disclosure describes an electrostatic force testing apparatus for applying an electrostatic force to a test specimen and thereby imparting stress on the specimen. A focused electrostatic force is applied to the test specimen using a shaped probe tip of the electrostatic force testing apparatus. The force applied to the test specimen may be varied based on a distance of the probe tip from the test specimen, a voltage applied to the probe tip, and a shape of the probe tip.

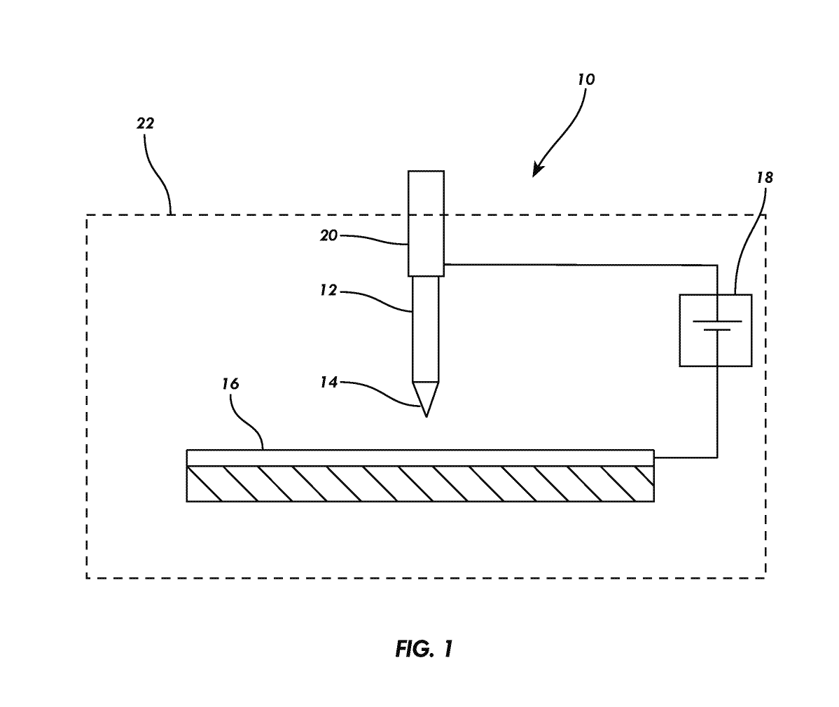

Referring now to FIG. 1, an electrostatic force testing apparatus 10 comprises a probe 12, a probe tip 14, a specimen 16, a voltage source 18 and an actuator 20. The testing apparatus 10 may be positioned within a chamber 22, such as the test chamber of an electron microscope.

The probe tip 14 is preferably formed of a geometric shape having a focused surface area at a point adjacent the specimen 16. For example, the probe tip may be conical in shape as shown in FIG. 1. Alternatively, the probe tip 14 may be a multi-sided pyramid or spherical in shape, or other suitable shapes for focusing an electrostatic force on the specimen 16. In yet another alternative, the probe tip may be a flat punch having a known surface area and shape. In another example, the probe tip 14 may be a tip designed for performing a nanoindentation hardness test, the tip having a small size and precise shape for imparting a nanoindentation on the specimen 16. The shape of the probe tip 14 may be selected based on a desired stress to be applied to the specimen 16.

When a potential difference is maintained between two surfaces, an electrostatic field is generated between them. This electric field results in a pulling force between the surfaces. Generally the force between a tip of an arbitrary geometry and a flat surface is calculated according to:

F=ε₀V²f(geometry,d)

where V is the applied voltage, f is a non-dimensional function of the tip geometry and tip-sample separation (d), and ε₀ represents the electrical permittivity of a medium where the apparatus is located, such as a vacuum. The functional dependence on the geometry and the separation between the two surfaces may be calculated for various geographic shapes, such as the exemplary shapes described herein.

Plane Surface Model:

The simplest illustration of the force between two conducting surfaces is that of a plate capacitor. The force between capacitor plates having a surface area A and separation d at an applied voltage V may be calculated as:

$$F = {ɛ}_{0} {V}^{2} \frac{A}{2 {d}^{2}}$$

Knife Edge Model:

The force between a surface and a thin wedge of width w and infinite length may be calculated as:

$$F = {ɛ}_{0} {V}^{2} \frac{2 w}{π d}$$

Sphere Model:

The force between a spherical tip of radius R and a flat surface separated by a distance d may be calculated as:

$$F = 2 π {ɛ}_{0} {V}^{2} {\sum }_{n = 1}^{∞} ( \frac{coth α - n coth ( n α )}{sinh ( n α )} ) , where$$

$$α = {cosh}^{- 1} ( \frac{d + r}{d} ) . \\ For d ≪ R , F = {ɛ}_{0} {V}^{2} \frac{π R}{d} .$$

The examples above illustrate the V² dependence of force (F) and the nonlinear dependence of the force on the separation distance (d). For other tip geometries, such as a 3-sided pyramid or a conical tip with a spherical cap, the electrostatic force may be calculated by the method of equivalent charges or by numerically solving the Laplace equation with appropriate boundary conditions.

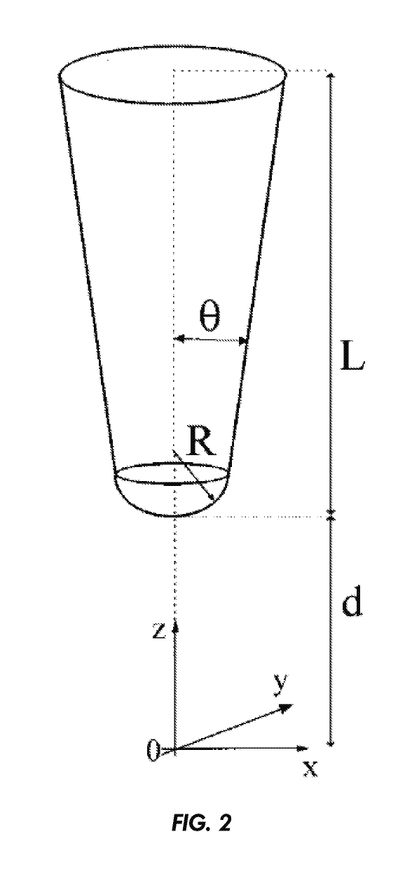

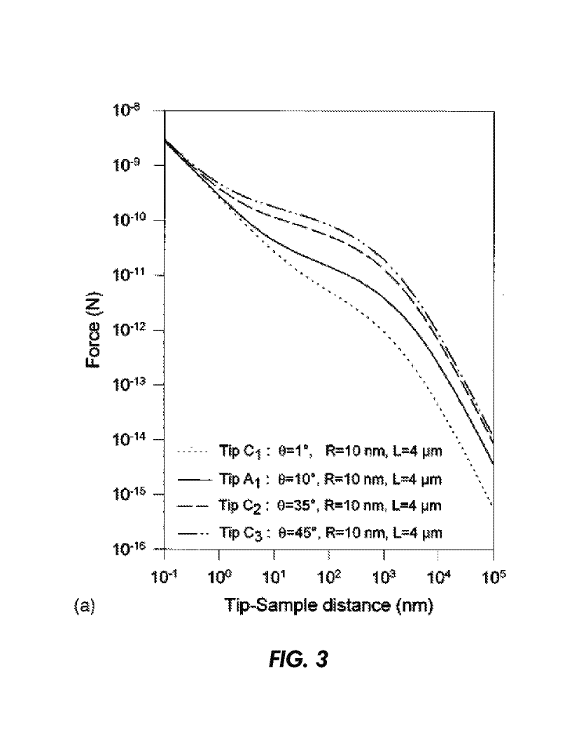

For example, for a tip geometry illustrated in FIG. 2, the electrostatic force on the tip as a function of tip-sample separation distance calculated using the method of equivalent charges is plotted in FIG. 3. The tip-sample separation distance may vary from about 0.01 μm to about 1,000 μm.

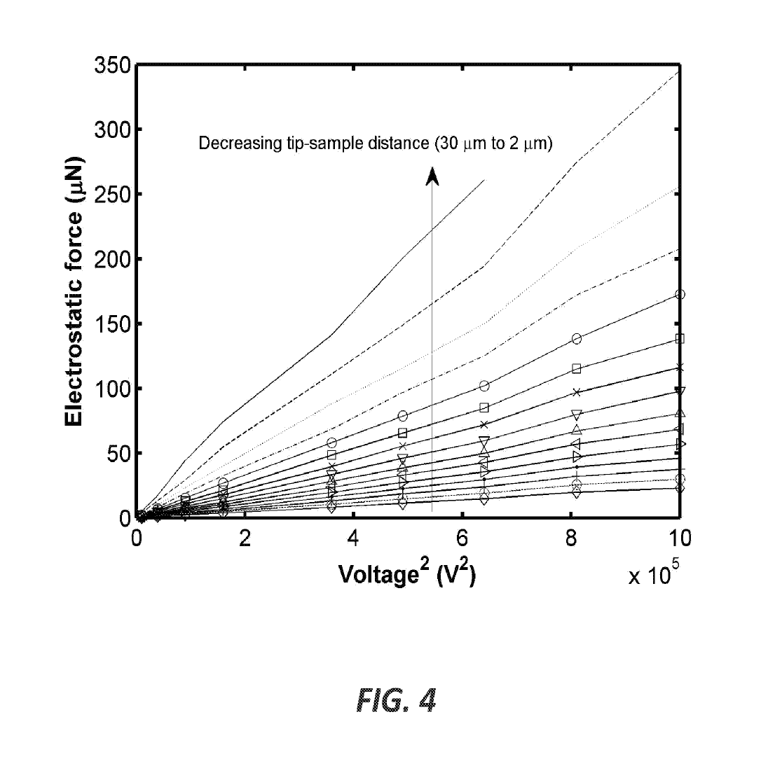

The electrostatic force on a 3-sided pyramidal tip in close proximity to a grounded sample surface as a function of the square of the applied voltage on the probe tip is shown in FIG. 4. FIG. 4 is a graph of the electrostatic force on the tip as a function of the square of the voltage at different tip sample separation distances (from about 2 μm to about 30 μm). As shown in FIG. 4, the electrostatic force on the probe tip has a linear correspondence with V² over a wide range of applied voltages and tip-sample separation distances. Further, FIG. 4 illustrates that as the tip-sample separation distance is decreased, the electrostatic force increases for a given voltage.

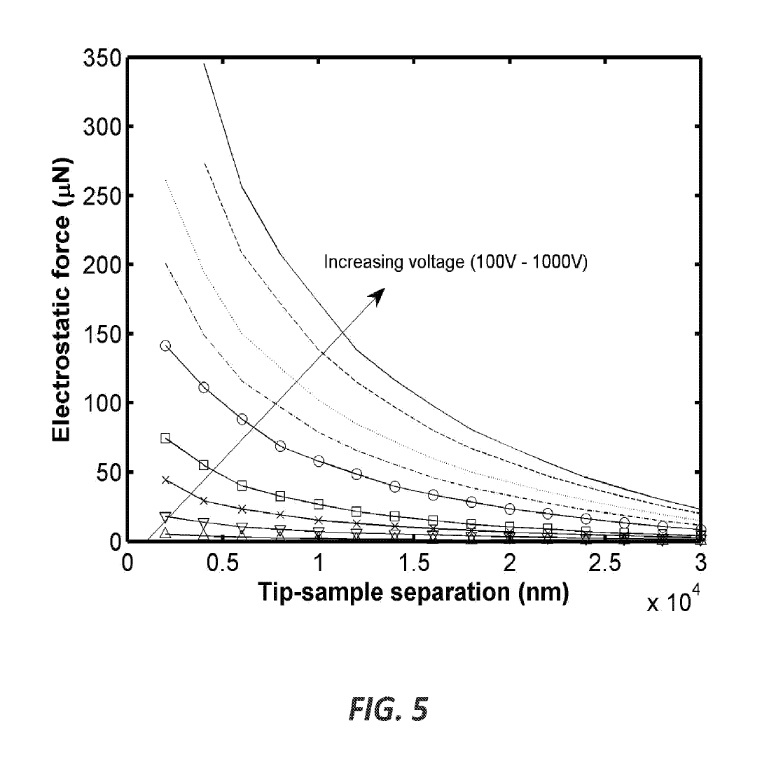

FIG. 5 is a graph of the electrostatic force on the tip as a function of tip-sample separation at different applied voltages (from about 100 V to about 1,000 V). FIG. 5 shows the non-linear dependence of electrostatic force as a function of tip-sample separation distance at various applied voltages.

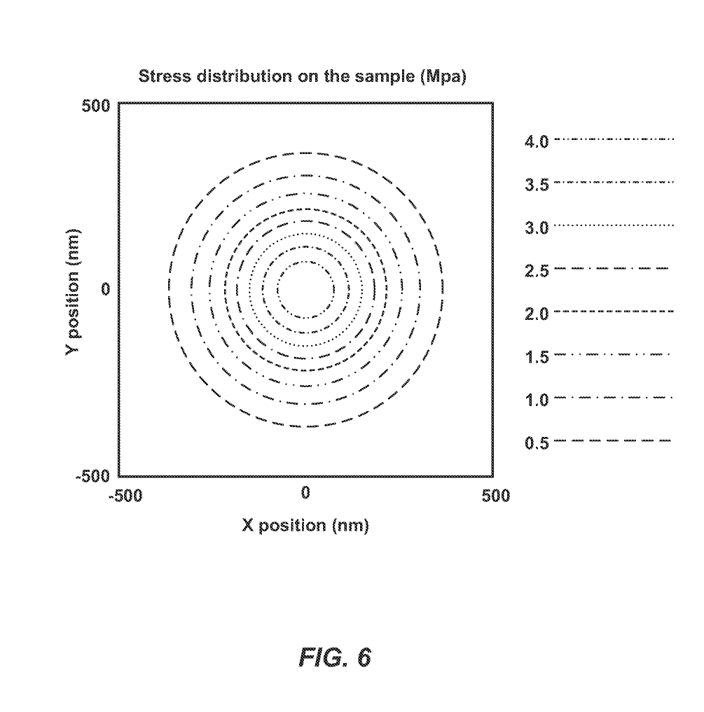

The force and stress distribution on the specimen 16 may be calculated by numerically solving the Laplace equation with appropriate boundary conditions. For example, FIG. 6 shows the stress distribution for a cone-shaped tip having a half cone angle θ of 70.3°, which is the conical equivalent to a standard Berkovich tip used in nanoindentation. The illustration of FIG. 6 shows a contour plot of the approximate stress distribution on the specimen 16 in the normal direction at an applied voltage of 1,000 V and a tip-sample separation distance of 500 nm. The stress distribution is axially symmetric based on the geometry of the cone-shaped tip. The stress distribution radially decays with the amount of radial decay varying based on the geometry of the tip and the surface of the specimen 16. The magnitude of stress imparted on the specimen by the probe tip is suitable for performing many small scale mechanical tests on the specimen.

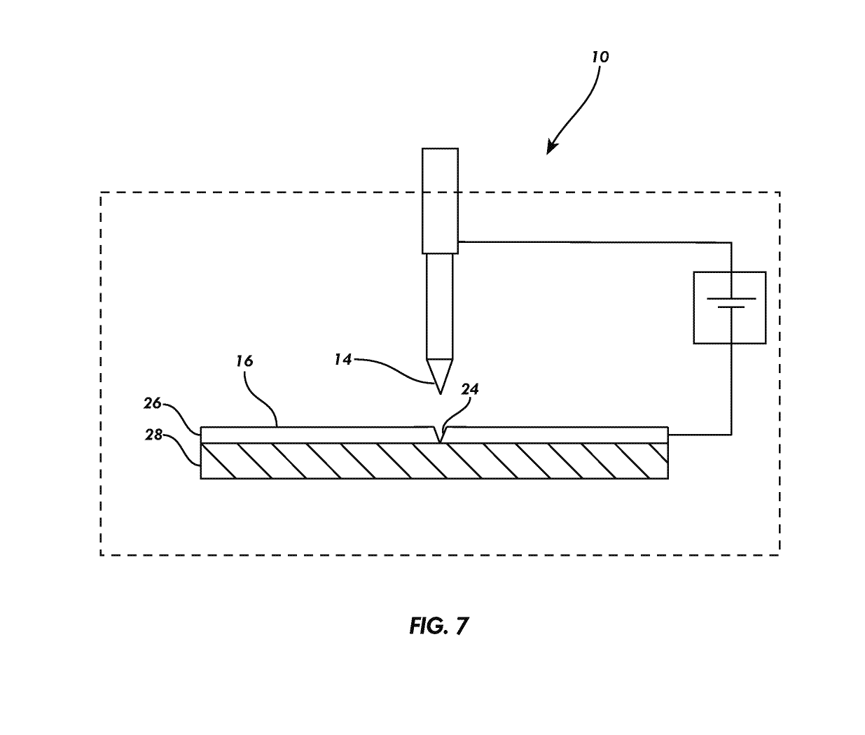

In one example depicted in FIG. 7, the electrostatic force testing apparatus 10 may be used to achieve a stable crack growth at an interface of a thin film 26 and a substrate 28. The probe tip 14 is positioned adjacent the thin film 26 of the specimen 16 and a voltage is applied to the probe tip 14. The distance between the probe tip 14 and the specimen 16 and the voltage applied to the probe tip may be varied based on the desired force to be imparted on the specimen as described above. Further, one of either the voltage or distance may be fixed while the other is varied, such as fixing the probe tip 14 at a desired distance from the specimen 16 while the voltage applied to the probe tip 14 is varied or applying a constant voltage to the probe tip while adjusting the distance between the probe tip 14 and the thin film 26. In another embodiment, a voltage may be applied to the probe tip by bombarding the probe tip with electrons from a scanning electron microscope.

The voltage may be applied to the probe tip directly by connecting a voltage source 18 across the thin film 26 and probe tip. The voltage source 18 may apply a constant voltage between the probe tip 14 and the specimen 16. Alternatively, the voltage source may apply cycles of increased and reduced voltage across the probe tip 14 and specimen 16. The applied voltage may have a range of from about 0.1V to about 10,000V.

In one embodiment, force and displacement measurements of the specimen 16 are made inside a Scanning Electron Microscope (SEM) using an InForce 50 actuator in combination with an InQuest controller, both from Nanomechanics, Inc. In another embodiment, a voltage may be applied to the probe tip 14 by bombarding the probe tip 14 with electrons from the SEM.

By applying the electrostatic force on a focused area of the specimen using the probe tip 14, the force required to propagate a crack in the specimen specimen 16 is measured. Further, because the electrostatic force is applied to a focused area of the specimen 16 based on the shape of the probe tip 14, the probe tip 14 exerts a force on the specimen 16 without physically contacting the specimen 16. As referred to herein, a focused area is an area on a surface of the specimen 16 having an area corresponding to an area of the probe tip. For example, for a spherical probe tip, the focused area is an area on the specimen adjacent the probe tip having a size substantially the same, greater than, or less than an area of the probe tip, such as the area shown in FIG. 6.

The effect of any imperfections present on the surface of the thin film 26 is reduced because the probe tip 14 focuses the electrostatic force on a limited surface area of the thin film 26. This greatly reduces the likelihood of an arc occurring between surface imperfections in the thin film and the probe tip 14 so long as the area adjacent the probe tip 14 is substantially free of imperfections or other contamination. A vacuum may be applied to the chamber 22 to provide a medium having a reduced permittivity to further reduce the likelihood of arcing occurring between the probe tip 14 and specimen 16.

In one embodiment, a flaw is introduced into the surface of the specimen 16 prior to applying an electrostatic force with the probe tip 14. The flaw initiates crack growth on the specimen when the electrostatic force is applied to the specimen. By introducing a flaw into the specimen 16 prior to applying an electrostatic force, the amount of force required to propagate the flaw in the specimen is reduced. Further, applying a flaw with known dimensions to the specimen 16 for measuring the force required to propagate the flaw allows the propagation force to be consistently measured because the dimensions of the initial flaw are known and controlled.

Introducing an initial flaw in the specimen 16 also modifies the shape of the surface of the specimen, thereby altering the stress distribution on the surface of the specimen 16 by the probe tip 14. For example, if a conical probe tip 14 is used, the probe tip may be contacted with the surface of the specimen 16 to create the initial flaw as shown in FIG. 7. By contacting the specimen with the conical probe tip, a flaw 24 is created having a shape that conforms to the shape of the probe tip 14. The probe tip 14 is then placed adjacent the flaw 24 at a desired tip-sample separation and a voltage is applied to create an electrostatic force on the specimen at the flaw. By modifying the surface of the specimen 16 to conform to the shape of the probe tip 14, the stress distribution across the surface of the specimen may be more constant relative to a flat surface of the specimen.

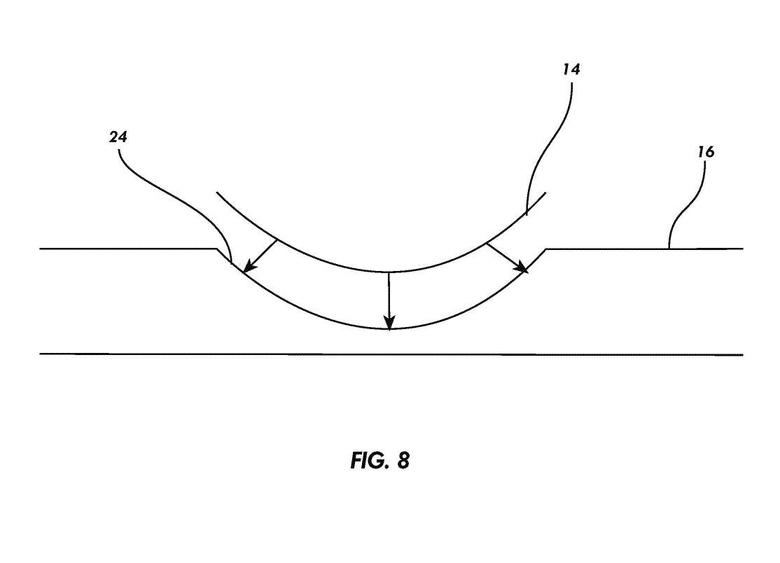

FIG. 8 is a close-up view of a probe tip 14 and flaw 24 created by the probe tip. Because the flaw 24 is created by the probe tip 14, the shape of the flaw 24 is substantially contoured to the shape of the probe tip 14. When the probe tip 14 is positioned adjacent the specimen and flaw 24 introduced therein, the distance between the probe tip 14 and flaw 24 of the specimen 16 is substantially consistent, creating a consistent stress distribution between the probe tip and specimen.

In one embodiment, a flaw in the surface of the specimen 16 may be introduced prior to applying an electrostatic force with the probe tip 14 to initiate separation of a thin film 26 from a substrate 28 of the specimen 16, as shown in FIG. 7. In one embodiment, the flaw is introduced using the probe tip 14, wherein the probe tip 14 is contacted with the surface of the specimen 16 after the specimen is inserted into the chamber 22 to create an indentation 24 in the surface of the thin film 26. The probe tip may also be used as an indentation tip to enable the testing apparatus to both perform an indentation hardness test and measure the adhesion of the thin film 26 to the substrate. In another embodiment, a flaw is introduced in the surface of the specimen 16 before inserting the specimen into the chamber 22 for testing.

Using the method above to introduce a flaw 24 and measure the force required to propagate a crack from the flaw 24 at the interface of the thin film 26 and substrate 28, the adhesion force of the thin film 26 to the substrate may be quantitatively analyzed. Further, this test may be repeated and consistent results obtained by introducing the same flaw at various points on the surface of the specimen 16.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A method of applying an electrostatic force to a test specimen comprising:
positioning a probe adjacent a surface of the test specimen at a separation distance of from about 0.01 μm to about 1,000 μm, the probe comprising a probe tip; and
applying a voltage of from about 0.1 V to about 10,000 V between the probe and the surface of the specimen,
thereby creating an electrostatic force on a portion of the surface of the test specimen that is adjacent the probe tip.

2. (canceled)

3. The method of claim 1 wherein the probe tip comprises a geometric shape configured to focus the electrostatic force on the portion of the surface of the test specimen that is adjacent the probe tip.

4. The method of claim 1 wherein the probe tip is conically shaped.

5. The method of claim 1 wherein the probe tip comprises a pyramidal shape.

6. The method of claim 1 wherein the probe tip is spherically shaped.

7. The method of claim 1 wherein the probe tip is configured to perform a nanoindentation hardness test.

8. The method of claim 1 wherein the electrostatic force comprises a pulling force between the probe tip and the surface of the test specimen.

9. The method of claim 1 further comprising determining the electrostatic force imparted on the surface of the test specimen based at least in part on the separation distance, a shape of the probe tip, and the voltage applied between the probe tip and the surface of the specimen.

10. The method of claim 1 further comprising determining the electrostatic force imparted on the surface of the test specimen based on the method of equivalent charges or based on a numerical solution of a Laplace equation with appropriate boundary conditions.

11. The method of claim 1 further comprising contacting the surface of the test specimen with the probe tip such that the probe tip creates an indentation in the surface of the test specimen having a shape substantially conforming to a shape of the probe tip.

12. The method of claim 1 further comprising varying the electrostatic force by varying one or more of the voltage applied between the probe and the surface of the specimen and the separation distance between the probe tip and the surface of the test specimen.

13. The method of claim 1 further comprising applying the voltage by bombarding the probe tip with electrons from a scanning electron microscope.

14. The method of claim 1 further comprising applying the voltage by connecting a constant voltage source across the probe tip and the surface of the test specimen.

15. The method of claim 1 further comprising applying the voltage by connecting a variable voltage source across the probe tip and the surface of the test specimen, and applying cycles of increased and reduced voltage between the probe tip and the surface of the specimen.

16. A method of testing the mechanical properties of a test specimen, the method comprising:
contacting a surface of the test specimen with a probe tip such that the probe tip creates an indentation having a shape substantially conforming to a shape of the probe tip;
positioning the probe tip adjacent the surface of the test specimen at a separation distance of from about 0.01 μm to about 1,000 μm;
applying a voltage of from about 0.1 V to about 10,000 V between the probe tip and the surface of the specimen, thereby creating an electrostatic force on a portion of the surface of the test specimen at the indentation; and
determining the electrostatic force imparted on the surface of the test specimen based at least in part on the separation distance, the shape of the probe tip, and the voltage applied between the probe tip and the surface of the specimen.

17. An apparatus for testing the mechanical properties of a test specimen, the apparatus comprising:
a probe having a probe tip;
an actuator operable to move the probe toward the test specimen to contact the probe tip with a surface of the test specimen, thereby creating an indentation in the surface of the test specimen having a shape substantially conforming to a shape of the probe tip;
the actuator further operable to position the probe tip adjacent the surface of the test specimen at a separation distance of from about 0.01 μm to about 1,000 μm; and
a voltage source connected across the probe tip and the surface of the test specimen, the voltage source operable to apply a voltage of from about 0.1 V to about 10,000 V between the probe tip and the surface of the specimen, thereby creating an electrostatic force on a portion of the surface of the test specimen at the indentation.

18. The apparatus of claim 17 wherein the probe tip comprises a geometric shape configured to provide a focused surface area at a point adjacent the surface of the test specimen.

19. The apparatus of claim 18 wherein the geometric shape of the probe tip is conical, pyramidal, or spherical.

20. The apparatus of claim 17 wherein the probe tip is configured to perform a nanoindentation hardness test.

21. The apparatus of claim 17 wherein the voltage source comprises a variable voltage source that is operable to apply cycles of increased and reduced voltage between the probe tip and the surface of the specimen.
